(19) United States
(12) Patent Application Publication
(10) Pub. No.: US 2006/0164963 A1
(43) Pub. Date: Jul. 27, 2006

(54) Recording medium, method and apparatus for determining type information of the recording medium, and method and apparatus for recording/reproducing data in/from the recording medium

(76) Inventors: Jea Yong Yoo, Seoul (KR); Kang Soo Seo, Anyang-si (KR); Byung Jin Kim, Seongnam-si (KR); Wae Yeul Kim, Anyang-si (KR); Soung Hyun Um, Anyang-si (KR)

Correspondence Address: HARNESS, DICKEY & PIERCE, P.L.C., P.O. BOX 8910, RESTON, VA, 20195, US

(21) Appl. No.: 11/332,249

(22) Filed: Jan. 17, 2006

(30) Foreign Application Priority Data
Jan. 25, 2005 (KR) 10-2005-0006807

(51) Int. Cl. G11B 7/24

(52) U.S. Cl. 369/275.3; 369/275.1

(57) ABSTRACT

A recording medium, a method for determining type information of a recording medium, and a method and apparatus for recording/reproducing data in/from the recording medium using the method are disclosed. The recording medium sequentially includes a lead-in area, a data area, and a lead-out area on the basis of an inner side. The data area and the lead-out area are designed to be read by a blue-ray optical beam. The lead-in area includes a first area readable by a red-ray optical beam and a second area readable by a blue-ray optical beam. Therefore, the recording medium can be applied to a fabrication process of a new optical recording/reproducing device for a high-density recording medium, and data can be effectively recorded/reproduced in/from the recording medium.

This application claims the benefit of Korean Patent Application No. 10-2005-0006807, filed on Jan. 25, 2005, which is hereby incorporated by reference as if fully set forth herein.

### BACKGROUND OF THE INVENTION

1. Field of the Invention

The present invention relates to a method for determining type information of a recording medium, a recording-medium structure for determining type information of the recording medium, and a method and apparatus for recording/reproducing data in/from the recording medium using the type-information determining method and the recording-medium structure.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a High Density DVD (HD-DVD).

The HD-DVD based on the next-generation recording medium technique has been considered to be the next-generation optical recording solution capable of storing much more data than a conventional DVD. In recent times, many developers have conducted intensive research into the international standard technical specification associated with the HD-DVD along with those of other digital devices.

However, although the optical recording/reproducing device must firstly determine whether a recording medium loaded in the optical recording/reproducing device is indicative of the HD-DVD when recording/reproducing data in/from the aforementioned next-generation recording medium such as the HD-DVD, a method for determining type information of the recording medium has not yet been established, such that many limitations and problems occur in developing the high-density optical recording/reproducing device.

### SUMMARY OF THE INVENTION

Accordingly, the present invention is directed to a recording medium, a method for determining type information of the recording medium, and a method and apparatus for recording/reproducing data in/from the recording medium, that substantially obviate one or more problems due to limitations and disadvantages of the related art.

An object of the present invention is to provide a method for determining type information of a recording medium, a recording-medium structure for determining type information of the recording medium, and a method and apparatus for recording/reproducing data in/from the recording medium using the type-information determining method and the recording-medium structure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium comprises: a lead-in area; a data area; and a lead-out area, wherein the lead-in area, the data area, and the lead-out area are sequentially arranged on the basis of an inner side of the recording medium, the data area and the lead-out area are designed to be read by a blue-ray optical beam, and the lead-in area includes a first area readable by a red-ray optical beam and a second area readable by a blue-ray optical beam.

In another aspect of the present invention, there is provided a recording medium comprising: a first lead-in area; a second lead-in area; a data area; and a lead-out area, wherein the first lead-in area, the second lead-in area, the data area, and the lead-out area are sequentially arranged on the basis of an inner side of the recording medium, the first lead-in area includes pits readable by a red-ray optical beam, and the second lead-in area, the data area, and the lead-out area include pits readable by a blue-ray optical beam.

In yet another aspect of the present invention, there is provided a recording medium comprising: a lead-in area; a data area; and a lead-out area, wherein the lead-in area, the data area, and the lead-out area are sequentially arranged on the basis of an inner side of the recording medium, the lead-in area includes pits readable by a red-ray optical beam, and the data area and the lead-out area include pits readable by a blue-ray optical beam.

In yet another aspect of the present invention, there is provided a method for determining type information of a recording medium comprising the steps of: a) determining type information of a recording medium classified according to position information of a recording layer contained in the recording medium via a vertical movement operation of a pickup unit; and b) determining type information of at least two recording mediums having the same recording layer position by reading information of a lead-in area of the recording medium using a red-ray optical beam.

In yet another aspect of the present invention, there is provided a method for recording/reproducing data in/from a recording medium comprising the steps of: a) if the recording medium is loaded, determining type information of the recording medium classified according to position information of a recording layer contained in the recording medium via a vertical movement operation of a pickup unit, and determining type information of at least two recording mediums having the same recording layer position by reading information of a lead-in area of the recording medium using a red-ray optical beam; and b) initially establishing a system suitable for recording/reproducing operations of the determined recording medium, and performing the recording/reproducing operations using the established system.

In yet another aspect of the present invention, there is provided an apparatus for recording/reproducing data in/from a recording medium comprising: a pickup unit for recording data in the recording medium using an optical beam, and reading data from the recording medium using the optical beam; and a microprocessor for determining type information of the recording medium classified according to position information of a recording layer contained in the recording medium via a vertical movement operation of the pickup unit, determining type information of at least two recording mediums having the same recording layer position by reading information of a lead-in area of the recording medium using a red-ray optical beam, initially establishing a system suitable for recording/reproducing operations of the determined recording medium, and performing the recording/reproducing operations using the established system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A˜1C show characteristics of general recording mediums;

FIGS. 2A˜2C shows pits formed on record tracks of individual recording mediums;

FIG. 3 is a block diagram illustrating an apparatus for recording/reproducing data in/from a recording medium according to the present invention;

FIG. 4 shows a recording-medium physical structure for determining type information of a recording medium in accordance with a first preferred embodiment of the present invention;

FIG. 5 shows a recording-medium physical structure for determining type information of a recording medium in accordance with a second preferred embodiment of the present invention; and

FIG. 6 is a flow chart illustrating a method for determining type information of a recording medium according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method for determining type information of a recording medium according to the present invention will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all recordable mediums such as an optical disc for recording/reproducing data upon receiving an optical beam, for example, a Compact Disc (CD), a DVD, and a HD-DVD, etc.

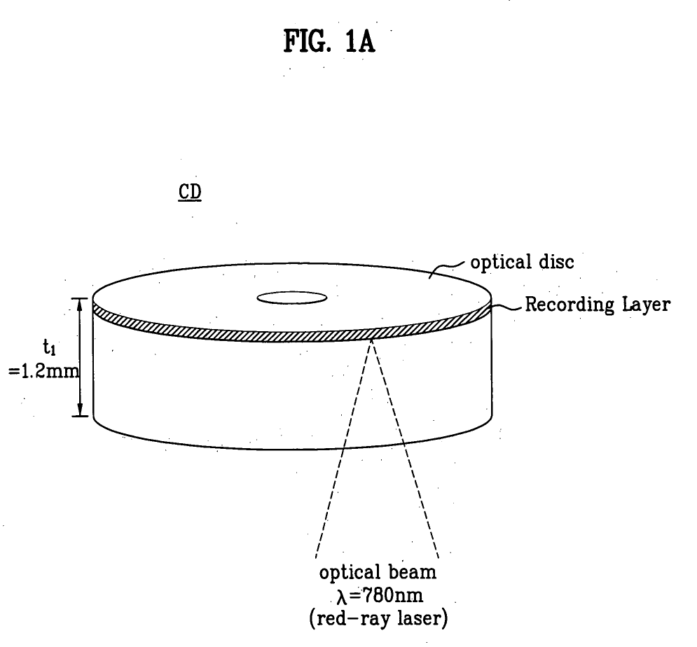

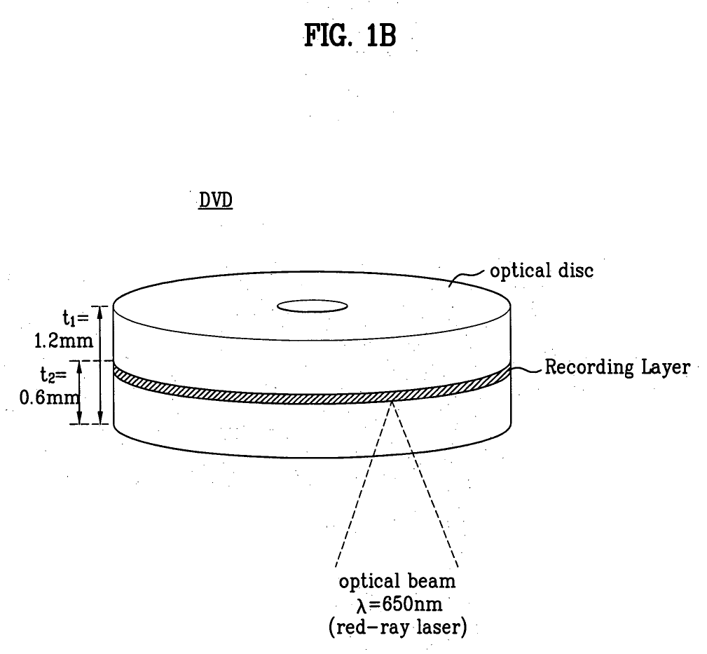

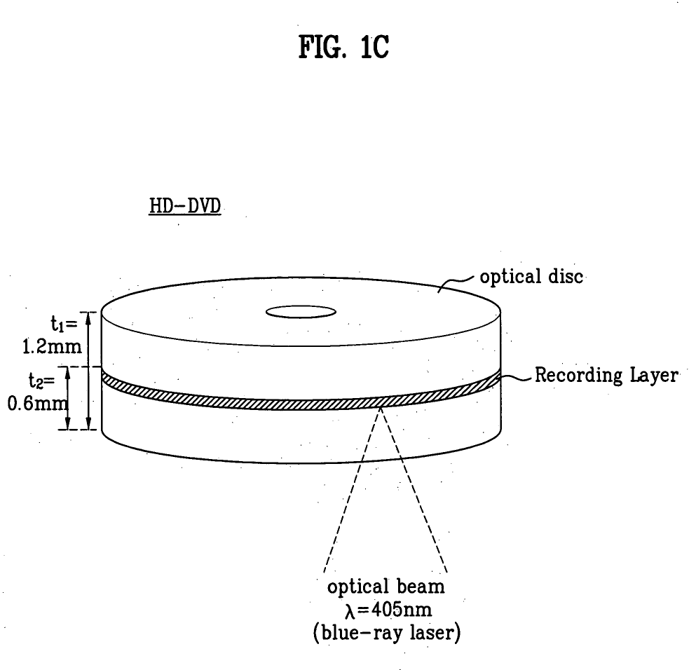

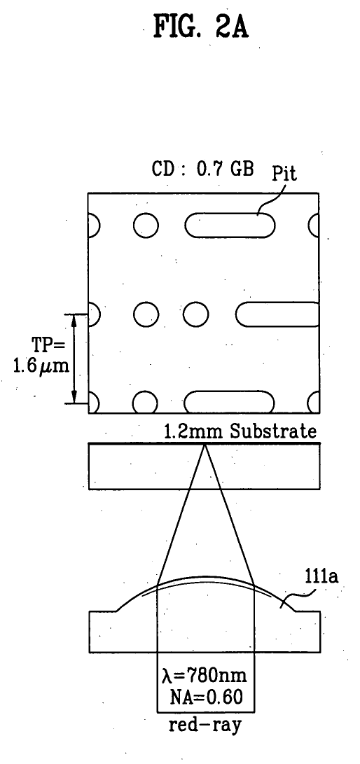

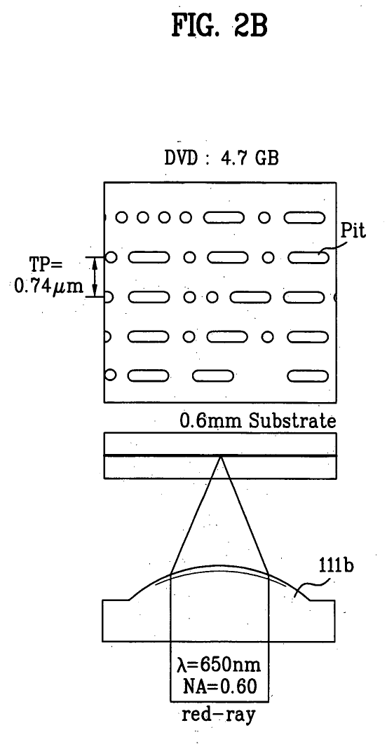

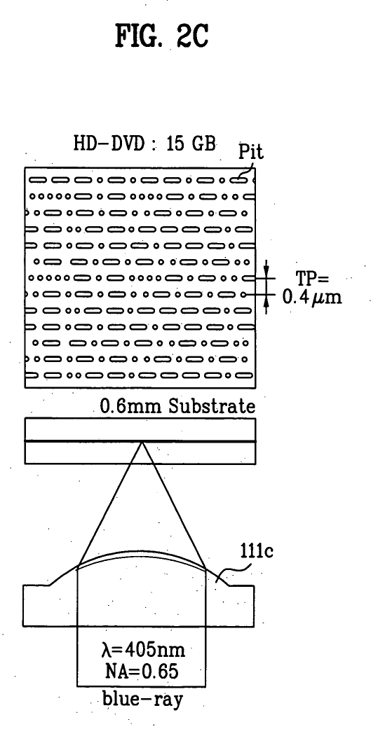

FIGS. 1A˜1C and FIGS. 2A˜2C show a variety of recording mediums according to the present invention. Particularly, FIGS. 1A˜1C and FIGS. 2A˜2C show characteristics of a CD, a DVD, and a HD-DVD. In association with the above-mentioned description, each disc (i.e., CD, DVD, or HD-DVD) has a thickness t1 of 1.2 mm and a diameter of 120 mm.

FIG. 1A shows a cross-sectional view illustrating the CD for the convenience of description. Referring to FIG. 1A, a recording layer contained in the CD is maximally spaced apart from an optical beam direction. Generally, the recording layer has the same thickness as the disc thickness t1 of 1.2 mm. Also, the CD uses a red-ray optical beam having a wavelength λ of 780 nm.

FIG. 1B shows a cross-sectional view illustrating the DVD for the convenience of description. Referring to FIG. 1B, a recording layer contained in the DVD is located at the center part on the basis of the optical beam direction. Generally, a specific position t2 is denoted by “t2=0.6 mm”, and is located at the center part of a total disc thickness t1 of 1.2 mm. More particularly, a recording layer having a thickness t2 of 0.6 mm is formed, and a substrate having the same size and thickness as those of the recording layer is deposited on the recording layer, such that the DVD is formed. The DVD uses a red-ray optical beam having a wavelength A of 650 nm.

FIG. 1C shows a cross-sectional view illustrating the HD-DVD for the convenience of description. Referring to FIG. 1C, a recording layer contained in the HD-DVD is located at the center part on the basis of the optical beam direction. Generally, a specific position t2 is denoted by “t2=0.6 mm”, and is located at the center part of a total disc thickness t1 of 1.2 mm. More particularly, similar to the DVD shown in FIG. 1B, a recording layer having a thickness t2 of 0.6 mm is formed, and a substrate having the same size and thickness as those of the recording layer is deposited on the recording layer, such that the HD-DVD is formed. The HD-DVD uses a blue-ray optical beam having a wavelength λ of 405 nm, differently from the DVD shown in FIG. 1B.

FIGS. 2A˜2C show a relationship between an optical beam and pits formed in the recording layer contained in each of the CD, the DVD, and the HD-DVD.

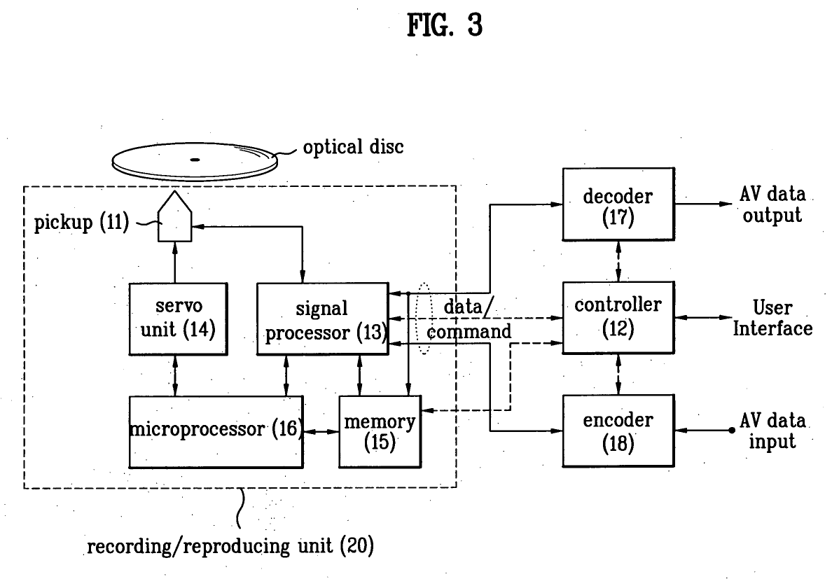

FIG. 2A shows a plan view of pits shown in the recording layer contained in the CD having a recording capacity of about 0.7 GB. Referring to FIG. 2A, if a red-ray optical beam having a wavelength λ of 780 nm is illuminated on a recording layer having a thickness of 1.2 mm via an objective lenses 111A having a specific NA (Numerical Aperture) of 0.45 in a pickup unit 11 shown in FIG. 3, pits each of which has a predetermined shape are formed. In this case, a distance between tracks on which the pits are formed is referred to as a TP (Track Pitch), and it can be recognized that the TP is set to 1.6 μm according to the present invention.

FIG. 2B shows a plan view of pits shown in the recording layer contained in the DVD having a recording capacity of about 4.7 GB. Referring to FIG. 2B, if a red-ray optical beam having a wavelength λ of 650 nm is illuminated on a recording layer having a thickness of 0.6 mm via an objective lenses 111B having a specific NA of 0.60 in a pickup unit 11 shown in FIG. 3, pits each of which has a predetermined shape are formed. In this case, a distance between tracks on which the pits are formed is referred to as a TP, and it can be recognized that the TP is set to 0.74 μm according to the present invention.

FIG. 2C shows a plan view of pits shown in the recording layer contained in the HD-DVD having a recording capacity of about 15 GB. Referring to FIG. 2C, if a blue-ray optical beam having a wavelength λ of 405 nm is illuminated on a recording layer having a thickness of 0.6 mm via an objective lenses 111C having a specific NA of 0.65 in a pickup unit 11 shown in FIG. 3, pits each of which has a predetermined shape are formed. In this case, a distance between tracks on which the pits are formed is referred to as a TP, and it can be recognized that the TP is set to 0.4 μm according to the present invention.

In association with the above-mentioned description, a plurality of objective lenses 111A, 111B, and 111C, each of which has a specific NA, in the pickup unit 11 of FIG. 3 may be composed of different objective lenses, or may be composed of a single objective lens. Otherwise, the objective lenses 111A and 111B are composed of a single objective lens, and the objective lens 111C is composed of another objective lens different from the single objective lens. In other words, the objective lens configuration of the present invention can be determined in various ways.

In more detail, referring to FIGS. 1A˜1C and FIGS. 2A˜2C, it can be recognized that a recording layer of the CD is arranged at a specific location different from those of individual recording layers of the DVD and the HD-DVD, and the CD has a longer distance between pits and a longer distance between TPs as compared to the DVD and the HD-DVD. Although the recording layer of the DVD is arranged at the same location as that of the HD-DVD, the DVD has a longer distance between pits and a longer distance between TPs as compared to the HD-DVD.

Therefore, it is obvious to those skilled in the art that system environments for recording/reproducing data in/from the aforementioned CD, DVD, and HD-DVD are different from each other. If any one of the CD, DVD, and HD-DVD is loaded in the optical recording/reproducing device, the optical recording/reproducing device must firstly determine type information of the loaded disc, must initially establish a unique system environment for the loaded disc on the basis of the determined type information, and must perform appropriate data recording/reproducing operations.

A method and apparatus for determining type information of a recording medium (e.g., CD, DVD, or HD-DVD), and a method and apparatus for determining recording/reproducing data in/from the recording medium according to the determined type information will hereinafter be described with reference to FIGS. 3 to 6.

FIG. 3 is a block diagram illustrating the optical recording/reproducing device according to the present invention.

Referring to FIG. 3, the optical recording/reproducing device includes a recording/reproducing unit 20 for recording/reproducing data in/from the optical disc and a controller 12 for controlling the recording/reproducing unit 20.

The recording/reproducing unit 20 includes a pickup unit 11, a signal processor 13, a servo unit 14, a memory 15, and a microprocessor 16. The pickup unit 11 directly records data in the optical disc, or reads data from the optical disc. The signal processor 13 receives a signal read from the pickup unit 11, restores the received signal to a desired signal value, or modulates a signal to be recorded into another signal recorded in the optical disc, such that it transmits the restored or modulated result. The servo unit 14 accurately reads a desired signal from the optical disc, or controls the pickup unit 11 to accurately record a signal in the optical disc. The memory 15 temporarily stores disc management information and data therein. The microprocessor 16 controls operations of the above-mentioned components. In association with the above-mentioned description, an optical recording/reproducing unit composed of only the recording/reproducing unit 20 is referred to as a drive, and is applicable to computer peripheral devices.

In association with the above-mentioned description, it is well known to those skilled in the art that the pickup unit 11 includes an optical-beam output unit, an objective lens for illuminating the output optical beam on a disc record layer, and a photo-detector for receiving a signal reflected from the disc, etc.

The controller 12 controls the aforementioned constituent components. Particularly, the controller 12 receives a user command via a user interface, and transmits a record/reproduction commands for recording/reproducing data in/from the optical disc to the aforementioned recording/reproducing unit 20 according to the received user command.

A decoder 17 finally decodes the signal read from the optical disc upon receiving a control signal from the controller 12, and provides the user with the decoded result.

An encoder 18 converts an input signal into a specific format signal (e.g., an MPEG2 transport stream) upon receiving a control signal from the controller 12, and transmits the converted result to the signal processor 13, such that a desired signal can be recorded in the optical disc.

In order to perform the record/reproduction commands via the controller 12, the recording/reproducing unit 20 must determine type information of the disc loaded in the optical recording/reproducing device, and must transmit the determined type information to the controller 12.

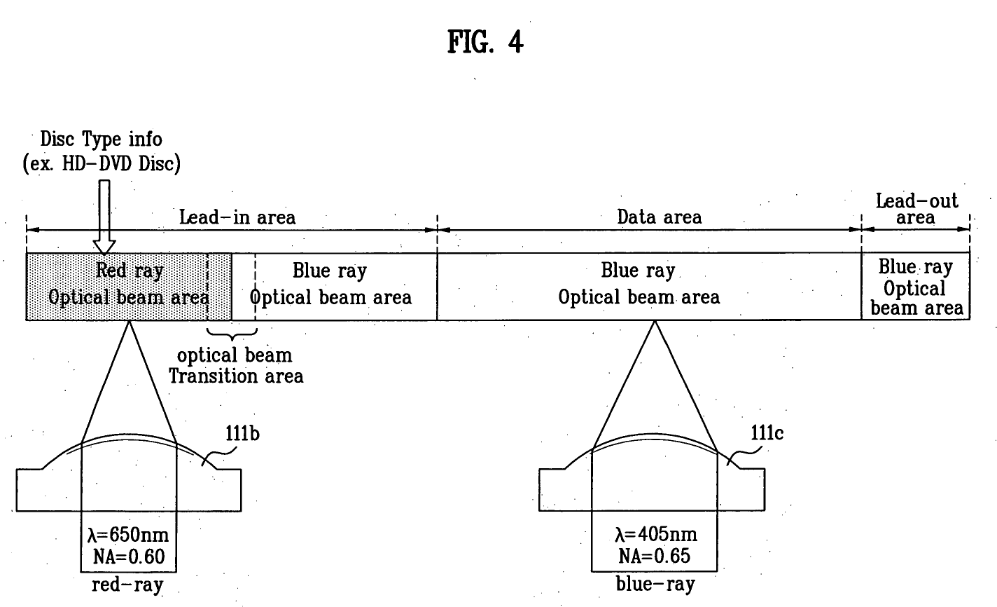

FIG. 4 shows a recording-medium physical structure for determining type information of a recording medium in accordance with a first preferred embodiment of the present invention. For the convenience of description, it should be noted that the recording medium depicted in FIG. 4 is indicative of a HD-DVD.

Referring to FIG. 4, a physical disc structure according to the first preferred embodiment of the present invention sequentially includes a lead-in area, a data area, and a lead-out area on the basis of an inner side of the disc. The data area and the lead-out area are designed to be read by a blue-ray optical beam. The lead-in area includes a first area capable of being read by a red-ray optical beam and a second area capable of being read by a blue-ray optical beam.

A transition area for changing an optical beam to another beam is located between the first area and the second area. Disc type information capable of determining a corresponding disc to be a HD-DVD is recorded in the first area. Therefore, if data of the first area contained in the lead-in area is reproduced by the red-ray optical beam serving as an initial optical beam, the optical recording/reproducing device can determine a corresponding disc to be the HD-DVD. Thereafter, an optical beam to be used is changed from the red-ray optical beam to the blue-ray optical beam in the aforementioned transition area, such that data is recorded/reproduced in/from the next area of the transition area using the blue-ray optical beam.

In association with the above-mentioned description, according to a modified example of the aforementioned first preferred embodiment, the first area and the second area of the lead-in area may be included in different lead-in areas, respectively. In this case, the first area may be set to a first lead-in area, data of which can be read by the red-ray optical beam. The second area may be set to a second lead-in area, data of which can be read by the blue-ray optical beam.

In other words, two lead-in areas (i.e., the first lead-in area and the second lead-in area) classified according to optical beam types are included in the disc, and the same information is recorded in the first lead-in area and the second lead-in area. Therefore, if a disc is loaded in the optical recording/reproducing device, the information stored in the first or second lead-in area can be read by any optical beam (i.e., the red-ray optical beam and the blue-ray optical beam).

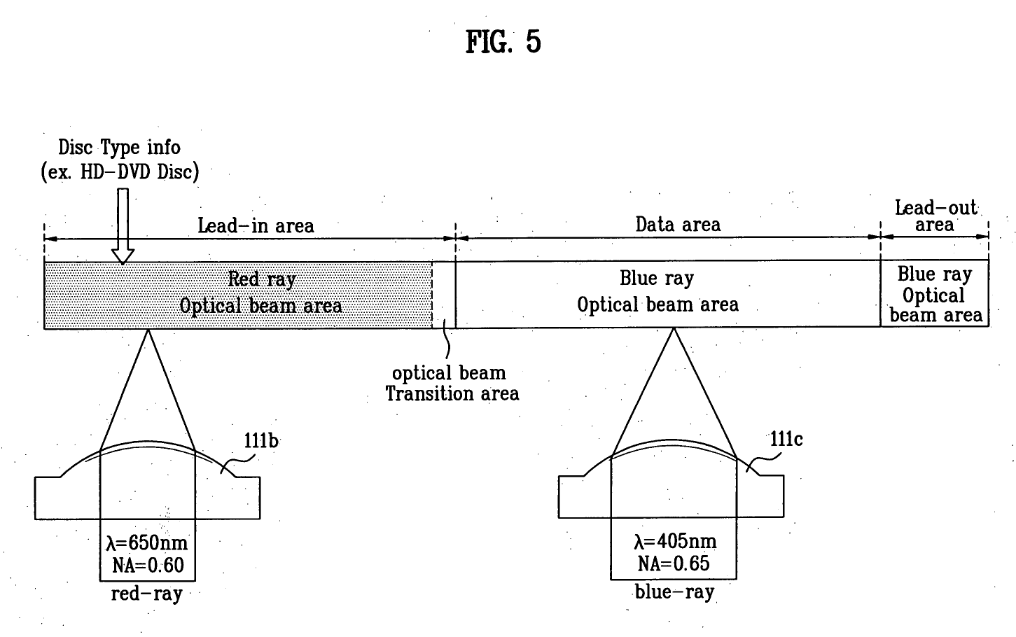

FIG. 5 shows a recording-medium physical structure for determining type information of a recording medium in accordance with a second preferred embodiment of the present invention. For the convenience of description, it should be noted that the recording medium depicted in FIG. 5 is indicative of a HD-DVD.

Referring to FIG. 5, a physical disc structure according to the first preferred embodiment of the present invention sequentially includes a lead-in area, a data area, and a lead-out area on the basis of an inner side of the disc. The lead-in area includes pits readable by a red-ray optical beam. The data area and the lead-out area include pits readable by a blue-ray optical beam.

A transition area for changing an optical beam to another beam is located between the lead-in area and the data area. Disc type information capable of determining a corresponding disc to be a HD-DVD is recorded in the lead-in area. Therefore, if data of the lead-in is reproduced by the red-ray optical beam serving as an initial optical beam, the optical recording/reproducing device can determine a corresponding disc to be the HD-DVD. Thereafter, an optical beam to be used is changed from the red-ray optical beam to the blue-ray optical beam in the aforementioned transition area, and data reproduction from the next area corresponding to the data area is performed by the blue-ray optical beam. Specifically, the recording-medium physical structure according to the second preferred embodiment of the present invention is unable to record data in the same manner as in a HD-DVD ROM, and is more effectively applicable to a read-only disc, data of which can be reproduced only.

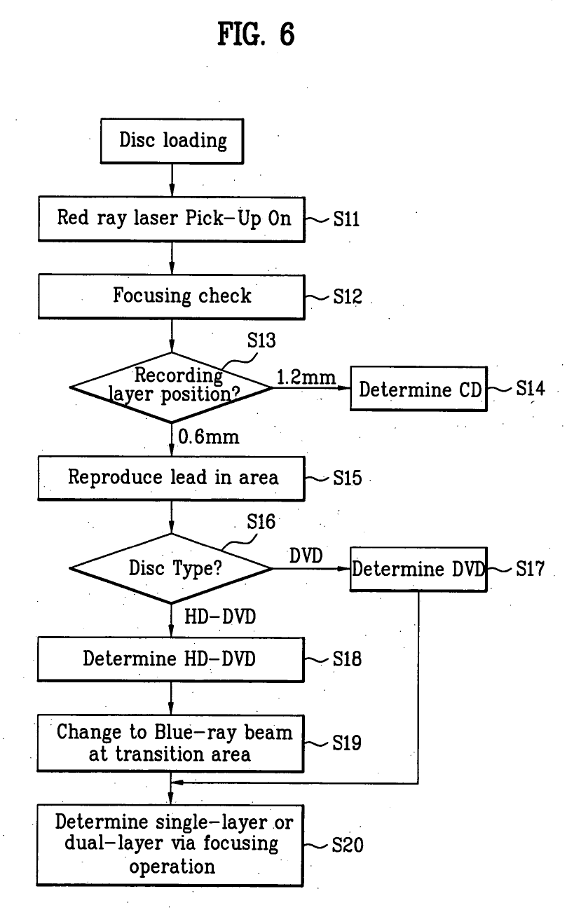

FIG. 6 is a flow chart illustrating a method for determining type information of a recording medium according to the present invention.

Referring to FIG. 6, the method for determining type information of the recording medium according to the present invention is characterized in that it firstly determines type information of the recording medium according to recording layer position information of the recording medium, and determines type information of at least two recording mediums having the same recording layer position by reading information of the recording medium lead-in area using the red-ray optical beam. Disc type information capable of recognizing type information of a corresponding recording medium is read from the lead-in area, such that the type information of the recording medium can be determined.

A recording-medium physical structure for use in the method for determining type information of the recording medium may occupy some parts of a total lead-in area read by the red-ray optical beam (i.e., the first preferred embodiment), or may occupy all the lead-in area (i.e., the second preferred embodiment).

For example, if an optical disc is loaded in the optical recording/reproducing device, the microprocessor 16 firstly switches on the red-ray optical beam at step S11, and allows the servo unit 14 to perform a focusing operation by which the pickup unit 11 moves up and down at step S12.

A recording layer position at which a signal is normally detected can be recognized by the aforementioned focusing operation at step S13. If the recording layer position at which the signal is normally received is determined to be 1.2 mm, the loaded disc is determined to be the CD at step S14. If the recording layer position at which the signal is normally received is determined to be 0.6 mm, the loaded disc is determined to be the DVD or the HD-DVD.

Thereafter, in order to discriminate between the DVD and the HD-DVD having the same recording layer position of 0.6 mm, the microprocessor 16 allows the pickup unit 11 to move, such that the pickup unit 11 reads data of the lead-in area contained in the recording-medium inner side at step S15. The disc type information from among all information reproduced in the lead-in area is determined at step S16. According to the determined disc type, the loaded disc may be determined to be a DVD at step S17, or may be determined to a HD-DVD at step S18. Thereafter, if the loaded disc is determined to be the HD-DVD at step S18, a current optical beam is changed to the blue-ray optical beam at the transition area.

If the loaded disc is determined to be the DVD at step S17 or is determined to be the HD-DVD at step S18, the focusing process is executed to determine the number of recording layers contained in the disc at step S20.

In association with the above-mentioned description, the DVD or the HD-DVD may have a single-layered structure or a dual-layered structure as necessary. Specifically, in the case of a dual-layered DVD or a dual-layered HD-DVD, two recording layers contained in the DVD or the HD-DVD are adjacent to each other, and the presence or absence of the recording layers adjacent to each other can be recognized by the vertical movement (i.e., the focusing operation) of the pickup unit. In more detail, if the pickup unit detects a normal signal via the vertical movement, the presence of the adjacent recording layers is determined. If the pickup unit detects an abnormal signal via the vertical movement, the absence of the adjacent recording layers is determined.

Therefore, the method for determining type information of a recording medium according to the present invention can determine a CD by recognizing position information of a recording layer, can determine a DVD or a HD-DVD on the basis of the lead-in area using the red-ray optical beam, and can determine the number of recording layers.

According to the determined result, the microprocessor 16 establishes initial environments (e.g., an optical beam to be used, a pickup objective lens, and a signal modulation method, etc.) as a system suitable for the determined disc type, and performs recording/reproducing operations upon receiving the record/reproduction commands from the controller 12.

As apparent from the above description, a method for determining type information of a recording medium, and a method and apparatus for recording/reproducing data in/from the recording medium using the method for determining the type information of the recording medium according to the present invention can be applied to a fabrication process of a new optical recording/reproducing device for a high-density recording medium, and can effectively record/reproduce data in/from the recording medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A recording medium comprising:
a lead-in area;
a data area; and
a lead-out area,
wherein the lead-in area, the data area, and the lead-out area are sequentially arranged on the basis of an inner side of the recording medium,
the data area and the lead-out area are designed to be read by a blue-ray optical beam, and
the lead-in area includes a first area readable by a red-ray optical beam and a second area readable by a blue-ray optical beam.

2. The recording medium according to claim 1, wherein the recording medium is a HD-DVD (High-Density DVD).

3. The recording medium according to claim 1, further comprising:
a transition area located between the first area and the second area to change a current optical beam to another optical beam.

4. The recording medium according to claim 1, wherein the first area includes type information of the recording medium.

5. The recording medium according to claim 1, wherein the first and second areas record the same information therein.

6. A recording medium comprising:
a first lead-in area;
a second lead-in area;
a data area; and
a lead-out area,
wherein the first lead-in area, the second lead-in area, the data area, and the lead-out area are sequentially arranged on the basis of an inner side of the recording medium,
the first lead-in area includes pits readable by a red-ray optical beam, and
the second lead-in area, the data area, and the lead-out area include pits readable by a blue-ray optical beam.

7. The recording medium according to claim 6, wherein the recording medium is a HD-DVD (High-Density DVD).

8. The recording medium according to claim 6, further comprising:
a transition area located between the first lead-in area and the second lead-in area to change a current optical beam to another optical beam.

9. The recording medium according to claim 6, wherein the first lead-in area and the second lead-in area include type information of the recording medium.

10. The recording medium according to claim 6, wherein the first and second lead-in areas record the same information therein.

11. A recording medium comprising:
a lead-in area;
a data area; and
a lead-out area,
wherein the lead-in area, the data area, and the lead-out area are sequentially arranged on the basis of an inner side of the recording medium,
the lead-in area includes pits readable by a red-ray optical beam, and
the data area and the lead-out area include pits readable by a blue-ray optical beam.

12. The recording medium according to claim 11, wherein the recording medium is a HD-DVD (High-Density DVD).

13. The recording medium according to claim 11, further comprising:
a transition area located between the lead-in area and the data area to change a current optical beam to another optical beam.

14. The recording medium according to claim 11, wherein the lead-in area includes type information of the recording medium.

15. A method for determining type information of a recording medium comprising the steps of:
a) determining type information of a recording medium classified according to position information of a recording layer contained in the recording medium; and
b) determining type information of at least two recording mediums having the same recording layer position by reading information of a lead-in area of the recording medium using a red-ray optical beam.

16. The method according to claim 15, wherein the information read from the lead-in area is indicative of recording-medium type information.

17. A method for recording/reproducing data in/from a recording medium comprising the steps of:
a) if the recording medium is loaded, determining type information of the recording medium classified according to position information of a recording layer contained in the recording medium, and determining type information of at least two recording mediums having the same recording layer position by reading information of a lead-in area of the recording medium using a red-ray optical beam; and
b) initially establishing a system suitable for recording/reproducing operations of the determined recording medium, and performing the recording/reproducing operations using the established system.

18. The method according to claim 17, wherein:
if the loaded disc is determined to be a HD-DVD (High-Density DVD), changing a current optical beam equal to the red-ray optical beam to a blue-ray optical beam at a transition area in which an optical beam transition is performed, and performing the recording/reproducing operations.

19. An apparatus for recording/reproducing data in/from a recording medium comprising:
a pickup unit for recording data in the recording medium using an optical beam, and reading data from the recording medium using the optical beam; and
a microprocessor for determining type information of the recording medium classified according to position information of a recording layer contained in the recording medium via a vertical movement operation of the pickup unit, determining type information of at least two recording mediums having the same recording layer position by reading information of a lead-in area of the recording medium using a red-ray optical beam, initially establishing a system suitable for recording/reproducing operations of the determined recording medium, and performing the recording/reproducing operations using the established system.

20. The apparatus according to claim 19, wherein:
if the loaded disc is determined to be a HD-DVD (High-Density DVD), changing a current optical beam equal to the red-ray optical beam to a blue-ray optical beam at a transition area in which an optical beam transition is performed, and performing the recording/reproducing operations.
